(19) United States
(12) Patent Application Publication
(10) Pub. No.: US 2006/0019154 A1
(43) Pub. Date: Jan. 26, 2006

(54) Separator for non-aqueous electrolyte battery and non-aqueous electrolyte battery

(76) Inventors: Naoki Imachi, Kobe-shi (JP); Seiji Yoshimura, Kobe-shi (JP)

Correspondence Address: KUBOVCIK & KUBOVCIK, SUITE 710, 900 17TH STREET NW, WASHINGTON, DC, 20006, US

(21) Appl. No.: 11/184,798

(22) Filed: Jul. 20, 2005

(30) Foreign Application Priority Data
Jul. 21, 2004 (JP) 2004-212575

(51) Int. Cl. H01M 2/16; B32B 27/34; B32B 27/32

(52) U.S. Cl. 429/144; 429/62; 428/473.5; 428/476.9

(57) ABSTRACT

A separator for non-aqueous electrolyte batteries is provided that has small heat shrinkage and achieves good heat resistance and good cycle performance. A non-aqueous electrolyte battery using the separator is also provided. A separator for non-aqueous electrolyte batteries includes a microporous film in which a polyolefin layer and a heat-proof layer are adhered. The heat-proof layer has a thickness of from 1 μm to 4 μm, and is formed of polyamide, polyimide, or polyamideimide having a melting point of 180° C. or higher. The air permeability of the separator is 200 sec/100 mL or less.

### BACKGROUND OF THE INVENTION

1. Field of the Invention

The present invention relates to battery separators for use in non-aqueous electrolyte batteries, such as lithium-ion secondary batteries and lithium polymer secondary batteries, and to non-aqueous electrolyte batteries using the separators.

2. Description of Related Art

With the popularity of portable devices tending to escalate, and owing to the advanced functions, greater power consumption, etc. of the devices, demand for higher capacity in the batteries used as the device power sources has been on the rise. Lithium-ion batteries and lithium polymer batteries, which are small in size and suitable for high-capacity applications owing to their characteristics, have been widely used as the main power sources of the portable devices such as mobile telephones and personal computers. Therefore, it has been necessary to increase the energy density of these batteries.

However, the development of new alternative high-energy materials to lithium cobalt oxide, used as the positive electrode active material, has been lagging, and for that reason, possibilities have in recent years been investigated of achieving increased energy density by reducing thickness of battery cans, separators, current collectors, and the like, that constitute the batteries.

Battery separators, for example, are provided for the purpose of preventing short circuits between the positive electrode and the negative electrode. This means that if the thickness of a separator is reduced excessively, a problem arises in terms of safety. The separator has a so-called shutdown (fuse) function, by which, when the temperature of a battery increases excessively, part of the separator melts and clogs pores in the separator to cut off electric current. The temperature at which the foregoing occurs is called the shutdown temperature. If the temperature rises further and the separator melts, creating large holes, a short circuit occurs between the positive electrode and the negative electrode. The temperature at which this happens is called the short circuit temperature. Generally, a battery separator needs to have a lower shutdown temperature and a higher short circuit temperature. When the thickness of separator is reduced, the short circuit temperature becomes lower; therefore, when a reduced separator thickness is desired, it is necessary that the heat resistance be enhanced.

Japanese Published Unexamined Patent Application No. 10-324758 discloses use of a porous film obtained by coating a substrate material composed of fibers and/or pulp with a para-aramid polymer as a separator for a battery such as a lithium secondary battery. This publication, however, merely aims at attaining a higher short circuit temperature by utilizing the heat resistance of para-aramid polymer, and does not show what characteristics are necessary for a battery separator to attain a reduced thickness and at the same time not degrade battery performance such as charge-discharge cycle performance.

### BRIEF SUMMARY OF THE INVENTION

Accordingly, it is an object of the present invention to provide a separator for non-aqueous electrolyte batteries that shows small heat shrinkage and achieves good heat resistance and good cycle performance. It is also an object of the invention to provide a non-aqueous electrolyte battery using the separator.

To accomplish the foregoing and other objects, the present invention provides a separator for non-aqueous electrolyte batteries, comprising: a microporous film in which a polyolefin layer and a heat-proof layer are adhered. The heat-proof layer has a thickness of from 1 μm to 4 μm, and is formed of polyamide, polyimide, or polyamideimide having a melting point of 180° C. or higher. The separator has an air permeability (the time it takes for 100 mL of air to pass through a film having a certain area) of 200 sec/100 mL.

### BRIEF DESCRIPTION OF THE DRAWINGS

FIG. 1 is a graph illustrating the relationship between cycle number and discharge capacity in Reference Experiment 1;

FIG. 2 is a graph illustrating the relationship between air permeability and degradation rate per one cycle in Reference Experiment 2; and

FIG. 3 is a graph illustrating the relationship between air permeability and thickness of separators in Reference Experiment 3.

### DETAILED DESCRIPTION OF THE INVENTION

The separator for non-aqueous electrolyte batteries of the present invention comprises a microporous film in which a polyolefin layer and a heat-proof layer are adhered, the heat-proof layer having a melting point of 180° C. or higher and being formed of polyamide, polyimide, or polyamideimide. In the separator of the present invention, a heat-proof layer formed of a heat-resistant resin such as polyamide is adhered with a polyolefin layer; therefore, its heat shrinkage characteristics can be considerably improved, and consequently, even when the thickness of the separator as a whole is reduced, the separator can have a small heat shrinkage ratio. For example, the thickness of the separator as a whole can be made 10 μm or less. By reducing the thickness of the separator, the energy density per volume in a Li-secondary battery can be increased, and a higher capacity is achieved.

In the present invention, the thickness of the heat-proof layer is 1 μm to 4 μm, more preferably 1.5 μm to 4 μm, and still more preferably 1.5 μm to 3 μm. When the thickness of the heat-proof layer is too small, the advantage of the heat-proof layer, that is, reduction of the heat shrinkage ratio, may not be obtained sufficiently. On the other hand, when the thickness of the heat-proof layer is too large, the separator tends to curl due to the difference in shrinkage characteristics between the polyolefin layer and the heat-proof layer.

In the present invention, the air permeability of the separator in which the polyolefin layer and the heat-proof layer are adhered is 200 sec/100 mL or less. When the air permeability exceeds 200 sec/100 mL, air permeation of the separator is poor and charge-discharge cycle performance of a battery degrades. Air permeability of the separator in the present invention may be measured according to Japanese Industrial Standard JIS P8117. Specifically, the time it takes for 100 mL of air to pass through a portion of a separator having an area of 645 mm² is defined as air permeability of the separator in the present invention.

In the present invention, it is preferable that the ratio of the thickness of the heat-proof layer to the thickness of the polyolefin layer (heat-proof layer:polyolefin layer) be (1):(1 or greater). When the thickness of the polyolefin layer is less than the foregoing ratio, the thickness of the heat-proof layer accordingly becomes thick; this may cause the separator to curl easily and is therefore undesirable.

In the present invention, the heat-proof layer is formed of polyamide, polyimide, or polyamideimide having a melting point or 180° C. or higher, as described above. In particular, those having a melting point of 200° C. to 400° C. are preferably used.

Examples of the polyamide include those having the structures as shown below. In the following structural formulae, R and R′ represent an aliphatic hydrocarbon group or an aromatic hydrocarbon group.
[-R—(C═O)—NH—]ₙ [-R—(C═O)—NH—R′—NH—(C═O)—]ₙ [—NR—(C═O)—]ₙ (1)

Examples of the polyimide include those having the structure as shown below. In the following structural formula, R and R′ represent an aliphatic hydrocarbon group or an aromatic hydrocarbon group.

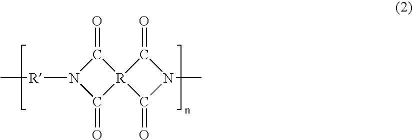

Examples of the polyamideimide include those having the structure as shown below.

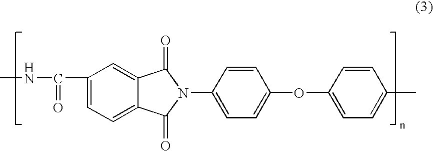

In the above structural formulae that represent polyamide, polyimide, and polyamideimide, the number n, which denotes degree of polymerization, is not particularly limited, but generally, it is preferable that n is about 50 to about 10000.

More preferably, the heat-proof layer in the present invention is comprised of a material represented by the formula
[13 CH₂—CH₂—C₆H₄—CH₂—(C═O)NH—]ₙ
having a melting point of 200° C. to less than 400° C.

It is particularly preferable that the heat-proof layer in the present invention be formed of a para-aromatic polyamide. The para-aromatic polyamide can be obtained through condensation polymerization of a para-aromatic diamine and a para-aromatic dicarboxylic acid halide. Alternatively, it can be obtained through ring-opening polymerization of a lactam or polycondensation of a ω-amino acid.

The polyolefin layer in the present invention may be formed of polyethylene, polypropylene, polyethylene-polypropylene copolymer, or the like. Especially preferable is one formed of polyethylene. To achieve the shutdown function as a fuse, it is preferable to use one having a melting point of about 120° C. to about 140° C.

The battery separator of the present invention comprises a microporous film in which a polyolefin layer and a heat-proof layer are adhered. The method for adhering the polyolefin layer and the heat-proof layer is not particularly limited. One example is a method involving coating a resin solution for forming the heat-proof layer on a polyolefin layer made of a microporous polyolefin film so as to be a predetermined thickness, and after the coating, immersing the coated film into a solution in which the solvent in the coating layer of the resin solution has been dissolved, to extract the solvent from the coating layer and dissolve it in the solution, whereby a microporous heat-proof layer is formed on the polyolefin layer.

By adjusting, for example, the resin concentration in the resin solution used for the coating, the number and size of pores in the heat-proof layer can be controlled.

It is preferable that a solvent such as N-methyl-2-pyrrolidone (NMP), N,N-dimethylformamide, or N,N-dimethylacetamide be used as the solvent in preparing the resin solution by dissolving polyamide or the like therein. Since these solvents can dissolve in water, it is possible to form the heat-proof layer by immersing, into water, the polyolefin layer on which the resin solution has been coated to separate the solvent out of the resin solution and dissolve it into water.

The present invention also provides a non-aqueous electrolyte battery comprising a positive electrode containing a positive electrode active material, a negative electrode containing a negative electrode active material, and a separator interposed between the positive electrode and the negative electrode, wherein the separator is the above-described separator according to the present invention.

The positive electrode active material is not particularly limited as long as it can be used for non-aqueous electrolyte batteries such as lithium secondary batteries. Examples thereof include a lithium-cobalt composite oxide (lithium cobalt oxide), a lithium-nickel composite oxide, a lithium-manganese composite oxide such as spinel-type lithium manganese oxide, and olivine-type phosphate compounds. Lithium-cobalt composite oxide and lithium-nickel composite oxide are particularly preferable.

The negative electrode active material is not particularly limited as long as it can be used for non-aqueous electrolyte batteries such as lithium secondary batteries. Examples include carbon materials such as graphite and coke, as well as tin oxide, metallic lithium, silicon, and mixtures thereof. Carbon materials such as graphite are particularly preferable.

The solute of the non-aqueous electrolyte may be any solvent that can be used for non-aqueous electrolyte batteries such as lithium secondary batteries, and examples include LiBF₄, LiPF₆, LiN(SO₂CF₃)₂, LiN(SO₂C₂F₅)₂, and LiPF₆₋ₓ(CₙF₂ₙ₊₁)ₓ (wherein 1<x<6 and n=1 or 2). These may be used either alone or in a combination of two or more of them. The concentration of the solute is preferably about 0.8 to 1.5 mole/liter.

Preferable examples of the solvent for the non-aqueous electrolyte include carbonate-based solvents such as ethylene carbonate, propylene carbonate, γ-butyrolactone, diethyl carbonate, ethyl methyl carbonate, and dimethyl carbonate. Particularly preferable is a mixed solvent of a cyclic carbonate such as ethylene carbonate or propylene carbonate, and a chain carbonate such as diethyl carbonate, ethyl methyl carbonate, or dimethyl carbonate.

The non-aqueous electrolyte in the present invention may be a polymer solid electrolyte using a gelled polymer. Examples of the polymer material include a polyether solid polymer, a polycarbonate solid polymer, a polyacrylonitrile solid polymer, an oxetane polymer, and an epoxy-based polymer, as well as a copolymer or a cross-linked polymer comprising two or more of them. Polyvinylidene fluoride (PVDF) may also be used. A solid electrolyte may be used in which any of these polymer materials, solutes, and solvents are combined and made into a gelled state.

According to the present invention, a separator for non-aqueous electrolyte batteries can be made available that has small heat shrinkage and good heat resistance. Moreover, the battery separator for non-aqueous electrolyte batteries according to the present invention can achieve good cycle performance.

### DESCRIPTION OF THE PREFERRED EMBODIMENTS

Hereinbelow, the present invention is described in further detail based on preferred embodiments thereof. It should be construed, however, that the present invention is not limited to the following preferred embodiments but various changes and modifications are possible unless such changes and variations depart from the scope of the invention.

First, reference experiments that were conducted using polyethylene separators will be discussed.

### Reference Experiment 1

Using polyethylene separators having various air permeabilities, a relationship between air permeability of separator and cycle life degradation was studied. Lithium secondary batteries were constructed using polyethylene separators having various air permeabilities as set forth in Table 1, and their cycle performance was evaluated by a cycle test. Each of the lithium secondary batteries was prepared in the following manner.

Preparation of Positive Electrode

Lithium-cobalt composite oxide (lithium cobalt oxide), a carbon conductive agent (SP300), and acetylene black were mixed at a weight ratio of 92:3:2, and 200 g of the mixture was charged into a mixer (mechanofusion system AM-15F made by Hosokawa Micron Corp.), which was operated at 1500 rpm for 10 minutes to mix it under compression, impact, and shearing actions, whereby a positive electrode mixture was prepared. Next, the positive electrode mixture was mixed with a fluoropolymer-based binder agent (PVDF) in NMP solvent so that the weight ratio of the positive electrode mixture to PVDF became 97:3 to prepare a positive electrode mixture slurry.

The resultant positive electrode mixture slurry was applied to both sides of an aluminum foil, and the resultant material was thereafter dried and pressure-rolled. Thus, a positive electrode was prepared. The amount of the positive electrode mixture slurry applied was 546 mg/10 cm², as the total for both sides, and the filling density was 3.57 g/mL.

Preparation of Negative Electrode

A negative electrode mixture slurry was prepared by mixing a carbon material (graphite), CMC (carboxymethylcellulose sodium), and SBR (styrene-butadiene rubber) in an aqueous solution at a weight ratio (graphite:CMC:SBR) of 98:1:1.

The resultant negative electrode mixture slurry was applied onto both sides of a copper foil, dried, and then pressure-rolled to form a negative electrode. The amount of the negative electrode mixture slurry applied was 240 mg/10 cm², as the total for both sides, and the filling density was 1.70 g/mL.

Preparation of Non-aqueous Electrolyte Solution

Ethylene carbonate (EC) and diethyl carbonate (DEC) were mixed at a volume ratio (EC:DEC) of 3:7, and into the resultant mixed solvent, LiPF₆ was dissolved at a concentration of 1.0 mole/liter. Thus, a non-aqueous electrolyte solution was prepared.

Construction of Battery

Lithium secondary batteries were constructed using the positive electrode, the negative electrode, and the non-aqueous electrolyte prepared in the manner described above, and employing as separators polyethylene separators having various thicknesses and air permeabilities as set forth in Table 1. Specifically, each of the lithium secondary batteries was constructed as follows. Respective lead terminals were attached to the positive electrode and the negative electrode, and the positive electrode and the negative electrode were wound in a spiral form with a separator interposed therebetween. The wound electrodes were then pressed into a flat shape to prepare an electrode assembly, and the prepared electrode assembly was inserted into a battery case made of aluminum laminate, followed by pouring the electrolyte solution into the battery case and sealing it. The design capacity, which is calculated from the amounts of the positive electrode active material and the negative electrode active material applied, is 880 mAh.

Measurement of Air Permeability of Separator

The air permeability of each of the separators was measured according to JIS P8117. The equipment used for the measurement was a B-type Gurley densometer (made by Toyo Seiki Seisaku-sho, Ltd.). A separator was fastened to a circular hole having a diameter of 28.6 mm and an area of 645 mm², and with an inner cylinder mass of 567 g, the air in the cylinder was passed through the test circular hole to the outside of the cylinder. The time it takes for 100 mL of air to pass through the separator was measured, and the measured value was employed as the air permeability of the separator.

Charge-discharge Cycle Test

Each of the batteries constructed as described above was discharged at a constant current of 1 C (850 mAh) to 4.2 V and charged at a constant voltage of 4.2 V to a current of C/20 (42.5 mAh). At 10 minutes after the completion of the charging, the battery was discharged at a constant current of 1 C (850 mAh) to 2.75 V. With this charge-discharge condition, a charge-discharge cycle test was carried out at 25° C. to measure the capacity retention ratio after 500 cycles. The capacity retention ratio is a capacity retention ratio with respect to the initial discharge capacity. The results of the measurement are shown in Table 1.

TABLE 1

| | | | | | | |
|---|---|---|---|---|---|---|
| Thickness (μm) | 9 | 12 | 10 | 25 | 26 | 23 |
| Air permeability | 320 | 190 | 220 | 101 | 570 | 80 |
| (sec/100 mL) | | | | | | |
| Capacity retention ratio | 75.0 | 82.2 | 78.1 | 84.3 | 68.3 | 85.2 |
| at the 500th cycle (%) | | | | | | |

As seen from Table 1, it is understood that the separators with greater air permeabilities (those with longer passage time), that is, those with poor air permeabilities, tend to have lower capacity retention ratios and more easily cause cycle life degradation. The results shown in Table 1 indicate that good cycle performance can be attained by setting the air permeability to 200 sec/100 mL or less. It is believed that the reason why the cycle life degradation tends to occur more easily when air permeability becomes greater (passage time becomes longer) is as follows. Specifically, it is thought that, at the initial stage of cycling, both the positive electrode active material and the negative electrode active material are in an active state and side reactions such as the decomposition of the electrolyte solution actively occur, in addition to the intercalation and deintercalation of Li ions. The decomposed product of the electrolyte solution or the like may deposit as impurities in the micropores of the separator as well as on the electrode surfaces, lessening the pores of the separator. It is believed that such lessening of the pores of the separator causes the cycle performance to degrade.

FIG. 1 is a graph showing the relationship between number of cycles and discharge capacity of a battery that employs a separator having an air permeability of 320 sec/100 mL (solid line) and a battery that employs a separator having an air permeability of 190 sec/100 mL (dotted line), both separators being shown in Table 1. The discharge capacities given herein are relative values when the discharge capacity at the initial cycle is taken as 100. As seen from FIG. 1, the capacity retention ratios considerably decrease before the 100th cycle. After the 100th cycle, both batteries shown in FIG. 1 exhibited similar degrees of discharge capacity decrease. Accordingly, it is understood that cycle performance of batteries can be evaluated by measuring their capacity retention ratios up to the 100th cycle.

### Reference Experiment 2

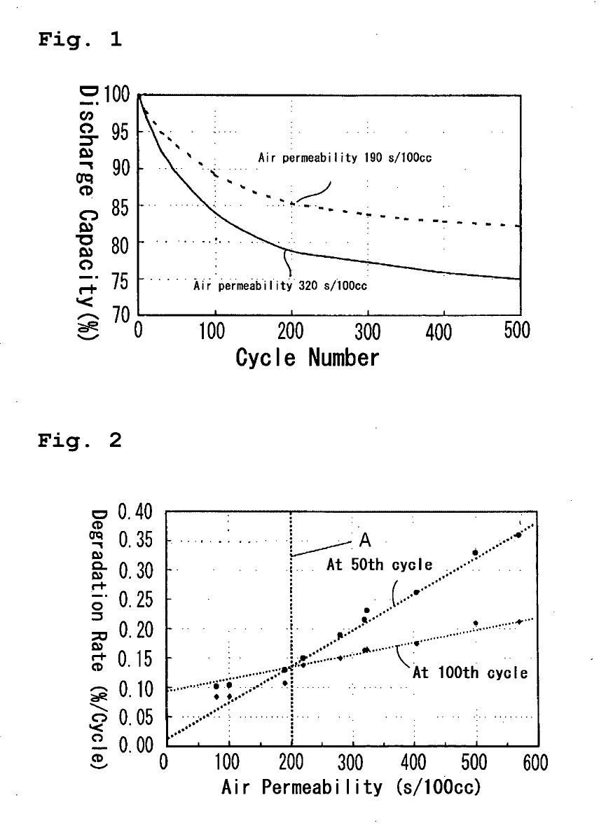

Lithium secondary batteries were fabricated in the same manner as in Reference Experiment 1, using the polyethylene separators having the air permeabilities set forth in Table 2. With the lithium secondary batteries fabricated, the capacity degradation rates per one cycle at the 50th cycle and at the 100th cycle (the rate of decrease in discharge capacity with respect to initial discharge capacity) were obtained. The results are shown in Table 2 and FIG. 2.

TABLE 2

| | | | | | |
|---|---|---|---|---|---|
| Thickness (μm) | 23 | 27 | 16 | 17 | 8 |
| Air permeability | 80 | 101 | 190 | 220 | 280 |
| (sec/100 mL) | | | | | |
| Capacity degradation | 0.102 | 0.104 | 0.13 | 0.15 | 0.19 |
| ratio per one cycle at | | | | | |
| the 50th cycle | | | | | |
| (%/cycle) | | | | | |
| Capacity degradation | 0.084 | 0.085 | 0.107 | 0.138 | 0.15 |
| ratio per one cycle at | | | | | |
| the 100th cycle | | | | | |
| (%/cycle) | | | | | |
| Thickness (μm) | 23 | 16 | 20 | 12 | 26 |
| Air permeability | 320 | 324 | 405 | 500 | 570 |
| (sec/100 mL) | | | | | |
| Capacity degradation | 0.216 | 0.232 | 0.262 | 0.33 | 0.36 |
| ratio per one cycle at | | | | | |
| the 50th cycle | | | | | |
| (%/cycle) | | | | | |
| Capacity degradation | 0.164 | 0.165 | 0.175 | 0.21 | 0.212 |
| ratio per one cycle at | | | | | |
| the 100th cycle | | | | | |
| (%/cycle) | | | | | |

Table 2 and FIG. 2 clearly demonstrate that the degradation rates per one cycle, that is, the capacity degradation ratios per one cycle, become higher as the air permeabilities of the separators become greater (as the passage time becomes longer). The capacity drops particularly sharply during the period before the 50th cycle. In FIG. 2, the dotted line A indicates an air permeability of 200 sec/100 mL. As clearly seen from FIG. 2, the capacity degradation per one cycle can be lessened by setting the air permeability to 200 sec/100 mL or less.

### Reference Experiment 3

The heat shrinkage characteristics of the polyethylene separators having film thicknesses and air permeabilities shown in Table 3 were evaluated in the following manner.

Measurement of Heat Shrinkage of Separator

A separator (5 cm×2 cm) was placed between slide glasses and, with both ends of the slide glasses fixed with clips, was retained at a predetermined temperature for 10 minutes; thereafter, percentage of shrinkage was measured.

The shrinkages of the separators at 120° C. are shown in Table 3.

TABLE 3

| | | | | | | | |
|---|---|---|---|---|---|---|---|
| Film thickness (μm) | 4 | 4 | 4 | 8 | 8 | 8 | 12 |
| Air permeability | 180 | 380 | 420 | 100 | 260 | 290 | 100 |
| (sec/100 mL) | | | | | | | |
| Shrinkage at | 32.6 | 20.0 | 19.6 | 29.4 | 19.9 | 18.4 | 24.6 |
| 120° C. (%) | | | | | | | |
| Film thickness (μm) | 12 | 12 | 12 | 16 | 16 | 16 | 16 |
| Air permeability | 190 | 210 | 320 | 60 | 170 | 200 | 324 |
| (sec/100 mL) | | | | | | | |
| Shrinkage at | 21.3 | 19.4 | 16.2 | 19.8 | 16.4 | 16.2 | 14.9 |
| 120° C. (%) | | | | | | | |
| Film thickness (μm) | 23 | 23 | 23 | 26 | 26 | 26 | |
| Air permeability | 80 | 100 | 320 | 90 | 190 | 210 | |
| (sec/100 mL) | | | | | | | |
| Shrinkage at | 16.1 | 16.0 | 14.8 | 15.4 | 13.8 | 13.8 | |
| 120° C. (%) | | | | | | | |

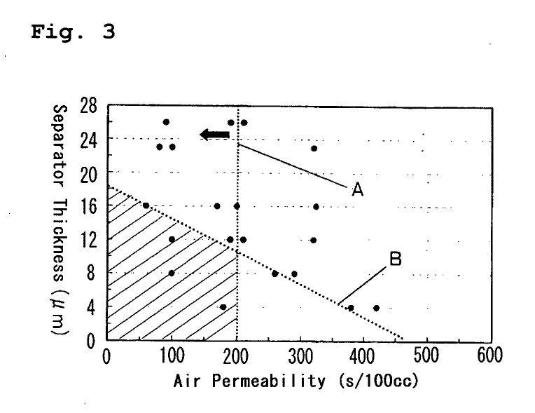

The film thicknesses and air permeabilities of the separators shown in Table 3 are plotted in FIG. 3. As for heat shrinkage of battery separators, it has been established according to the thermal test for batteries specified by the UL standard that the risk of internal short circuits is significantly low when the shrinkage at 120° C. is 20% or less. Therefore, it is desirable that the shrinkage of a battery separator at 120° C. be 20% or less. The dotted line B in FIG. 3 represents the boundary line at which the shrinkage at 120° C. becomes 20% or less. In the region below the dotted line B, the shrinkage at 120° C. can be made 20% or less. The dotted line A in FIG. 3 indicates where the air permeability is 200 sec/100 mL. That is, the area on the left side of the dotted line A is a region in which the air permeability can be 200 second or less. In the present invention, the region that is on the left side of the dotted line A and below the dotted line B in FIG. 3, that is, the hatched area in FIG. 3, is a desirable region.

### Experiment 1

### Examples 1 to 3 and Comparative Examples 9 to 10

### Preparation of Separator Comprising Layered Microporous Film

A polyamide having a melting point of 295° C., which had the structure as shown below, was used as a heat-resistant resin.
-[-R—(C═O)—NH—]ₙ— (4)

In the above structural formula, R denotes a hydrocarbon group represented by the following formula.
R=—CH₂—CH₂—C₆H₄—CH₂— (substituent is bonded to the p-position) (5)

The foregoing polyamide was dissolved in NMP solvent so that the concentration became 1 mole/liter, to prepare a heat-resistant resin solution. This resin solution was applied onto a microporous polyethylene film used for the later-described separator of Comparative Example 1 (thickness: 4 μm, air permeability: 190 sec/100 mL) to a predetermined thickness, and the film was immersed in water to dissolve the NMP in the resin coating film into water to remove it, whereby a polyamide film was precipitated. Thus, a microporous heat-proof layer made of polyamide was formed on the microporous polyethylene film. The thicknesses of the heat-proof layers were 1 μm for Example 1, 2 μm for Example 2, 3 μm for Example 3, 5 μm for Comparative Example 9, and 10 μm for Comparative Example 10.

The air permeabilities of the separators comprising the layered microporous films thus obtained were measured in the same manner as described in the foregoing. In addition, their shrinkages at 120° C., 130° C., 140° C., and 150° C. were also measured in the same manner as in the foregoing. The results of the measurements are shown in Table 4.

### Examples 4 to 6

Using a microporous polyethylene film having a thickness of 5 μm and an air permeability of 190 sec/100 mL for Example 4, a microporous polyethylene film having a thickness of 7 μm and an air permeability of 175 sec/100 mL for Example 5, and a microporous polyethylene film having a thickness of 8 μm and an air permeability of 190 sec/100 mL for Example 6, heat-proof layers comprising polyamide were formed in the same manner as in the foregoing. The thicknesses of the heat-proof layers were 2 μm for Example 4, 3 μm for Example 5, and 2 μm for Example 6.

The air permeabilities of the separators thus obtained were measured. The results are shown in Table 4. The shrinkages at 120° C., 130° C., 140° C., and 150° C. were also measured, the measurement results of which are shown in Table 4.

Each of the numerical values in the row of Table 4, where the film thicknesses for Examples 1 to 6 and Comparative Examples 9 and 10 are shown, represent the film thickness of each polyethylene layer (polyolefin layer) and the film thickness of each polyamide layer (heat-proof layer). For example, “4+1” in Example 1 means that the film thickness of the polyethylene layer is 4 μm and the film thickness of the polyamide layer is 1 μm, respectively.

### Comparative Examples 1 to 8

Polyethylene separators having thicknesses and air permeabilities as set forth in Table 4 were used as separators of Comparative Examples 1 to 8. The respective shrinkages of the separators at 120° C., 130° C., 140° C., and 150° C. were measured, the results of which are shown in Table 4.

Thermal Test at 150° C.

Lithium secondary batteries were fabricated in the same manner as in Reference Experiment 1, except that the separators of Examples 1 to 6 and Comparative Examples 1 to 10 were employed, and the batteries were subjected to a thermal test at 150° C. The lithium secondary batteries were charged at a constant current of 1 C (850 mA) to 4.31 V, and after the voltage reached 4.31 V, they were further subjected to constant voltage charging until the current reached C/50 (17 mA). The batteries were heated from 25° C. to 150° C. at a temperature elevation rate of 5° C./minute and then set aside at 150° C. for 3 hours, and the batteries were checked if anomalies such as internal short circuits occurred. The results are shown in Table 4. In Table 4, the “pass” designation indicates that no internal short circuit occurred, while the “fail” designation indicates that an internal short circuit did occur.

TABLE 4

| | | Comp. | Comp. | Comp. | Comp. | Comp. | Comp. | Comp. | Comp. |
|---|---|---|---|---|---|---|---|---|---|
| | | Ex. 1 | Ex. 2 | Ex. 3 | Ex. 4 | Ex. 5 | Ex. 6 | Ex. 7 | Ex. 8 |
| Material | | PE | PE | PE | PE | PE | PE | PE | PE |
| Film thickness | | 4 | 8 | 8 | 10 | 10 | 12 | 20 | 25 |
| (μm) | | | | | | | | | |
| Air permeability | | 190 | 200 | 260 | 150 | 210 | 160 | 80 | 101 |
| (sec/100 mL) | | | | | | | | | |
| Shrinkage | 120° C. | 23.2 | 22.0 | 20.0 | 23.9 | 19.0 | 18.5 | 19.4 | 17.8 |
| (%) | 130° C. | 31.2 | 33.4 | 32.4 | 33.7 | 30.9 | 30.6 | 29.8 | 28.4 |
| | 140° C. | 34.6 | 33.9 | 32.9 | 34.1 | 32.5 | 31.5 | 30.4 | 29.3 |
| | 150° C. | 35.2 | 35.3 | 33.3 | 35.6 | 33.4 | 33.5 | 31.5 | 30.1 |
| Remarks | | | | | | | | | |

| | | | | | | | | |
|---|---|---|---|---|---|---|---|---|
| Thermal test at | Fail | Fail | Pass | Fail | Pass | Pass | Pass | Pass |
| 150° C. | | | | | | | | |

| | | | | | Comp. | Comp. | | | |
|---|---|---|---|---|---|---|---|---|---|
| | | Ex. 1 | Ex. 2 | Ex. 3 | Ex. 9 | Ex. 10 | Ex. 4 | Ex. 5 | Ex. 6 |
| Material | | PE/PA | PE/PA | PE/PA | PE/PA | PE/PA | PE/PA | PE/PA | PE/PA |
| Film thickness | | 4 + 1 | 4 + 2 | 4 + 3 | 4 + 5 | 4 + 10 | 5 + 2 | 7 + 3 | 8 + 2 |
| (μm) | | | | | | | | | |
| Air permeability | | 190 | 190 | 200 | 200 | 230 | 180 | 190 | 200 |
| (sec/100 mL) | | | | | | | | | |
| Shrinkage | 120° C. | 20.0 | 0.1 | 0.0 | 0.0 | 0.0 | 0.0 | 0.0 | 0.0 |
| (%) | 130° C. | 24.2 | 0.1 | 0.0 | 0.0 | 0.0 | 0.0 | 0.0 | 0.0 |
| | 140° C. | 25.3 | 0.2 | 0.0 | 0.0 | 0.0 | 0.1 | 0.0 | 0.1 |
| | 150° C. | 26.4 | 0.2 | 0.0 | 0.0 | 0.0 | 0.1 | 0.0 | 0.1 |
| Remarks | | | | | Small curl | Fracture | | | |

| | | | | | | | | |
|---|---|---|---|---|---|---|---|---|
| Thermal test at | Pass | Pass | Pass | Pass | Pass | Pass | Pass | Pass |
| 150° C. | | | | | | | | |

The results for Comparative Examples 1 to 8 clearly demonstrate that the separators having a thickness of 10 μm or less and an air permeability of 200 sec/100 mL or less (Comparative Examples 1, 2 and 4) exhibited a shrinkage of 20% or greater at 120° C. and caused internal short circuits in the thermal test at 150 ° C.

In contrast, with Examples 1 to 6, no internal short circuit occurred in the thermal test at 150° C. even though the overall thicknesses were 10 μm or less and the air permeabilities were 200 sec/100 mL or less.

In Comparative Example 9, a curl occurred on the heat-proof layer side of the separator because the thickness of the heat-proof layer was 5 μm, that is, greater than 4 μm. In Comparative Example 10, a fracture occurred because the thickness of the heat-proof layer was very large, 10 μm. These results demonstrate that it is preferable that the thickness of the heat-proof layer be in the range of from 1 μm to 4 μm. Moreover, the shrinkages of Examples 2 and 3 were far less than that of Example 1. This demonstrates that it is more preferable that the thickness of the heat-proof layer be in the range of from 1.5 μm to 4 μm.

### Experiment 2

### Example 7

A lithium secondary battery was fabricated in the same manner as in Example 1 except that, a lithium-transition metal composite oxide (lithium-nickel composite oxide) shown in Table 5, which contains nickel, manganese, and cobalt as transition metals was used as the positive electrode active material, in place of lithium-cobalt composite oxide (lithium cobalt oxide).

### Example 8

A lithium secondary battery was fabricated in the same manner as in Example 1 except that, a lithium-manganese composite oxide shown in Table 5 was used as the positive electrode active material, in place of lithium-cobalt composite oxide.

Thermal Test at 150° C. and 160°

The above-described batteries thus fabricated were subjected to thermal tests at 150° C. and 160° C. The thermal test at 160° C. was carried out in the same manner as in the thermal test at 150° C. except that the batteries were heated to 160° C., rather than 150° C. The evaluation results are shown in Table 5.

TABLE 5

| | Example 1 | Example 7 | Example 8 |
|---|---|---|---|
| Positive | LiCoO₂ | LiNi_{1/3} | Li₂Mn₂O₄ |
| electrode | | Mn_{1/3}Co_{1/3}O₂ | |
| active | | | |
| material | | | |
| Negative | Artificial | Artificial | Artificial |
| electrode | graphite | graphite | graphite |
| active | | | |
| material | | | |
| Thermal test | Pass | Pass | Pass |
| at 150° C. | | | |
| Thermal test | Pass | Pass | Fail |
| at 160° C. | | | |

As clearly seen from the results shown in Table 5, during the thermal test at 160° C., an internal short circuit occurred in Example 8, which used lithium-manganese composite oxide as the positive electrode active material. In contrast, even with the thermal test at 160° C., no internal short circuit occurred in Example 1, which utilized lithium-cobalt composite oxide as the positive electrode active material, and Example 7, which utilized lithium-nickel composite oxide as the positive electrode active material. It is well-known that the active materials of lithium-cobalt composite oxide and lithium-nickel composite oxide expand several percent in volume through charge-discharge operations. It is believed that this causes the electrodes to clamp the separator firmly therebetween, preventing its heat shrinkage from occurring easily. On the other hand, lithium-manganese composite oxide shrinks by charge-discharge operations owing to its crystal structure; therefore, the structural pressure of the battery does not increase considerably, and the force with which the electrodes clamp the separator therebetween is weak. Consequently, heat shrinkage occurs more easily, and thus, it is believed that an internal short circuit occurred in the thermal test at 160° C.

Thus, it will be appreciated that internal short circuits can be prevented from occurring by utilizing lithium-cobalt composite oxide or lithium-nickel composite oxide as the positive electrode active material and utilizing a carbon material as the negative electrode active material.

Although the foregoing examples have illustrated separators with a double layer structure in which a heat-proof layer is formed on a polyolefin layer (polyethylene layer), such a layered structure should not limit the present invention. For example, a triple layer structure of polyolefin layer/heat-proof layer/polyolefin layer may be employed. Employing the triple layer structure means that polyolefin layers inevitably exist on the surfaces. Because polyolefin has a small friction, providing the surfaces with polyolefin layers allows a wound assembly to easily be pulled out from the center pin in winding electrodes, which increases productivity of the batteries.

Only selected embodiments have been chosen to illustrate the present invention. To those skilled in the art, however, it will be apparent from the foregoing description that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese patent application No. 2004-212575 filed Jul. 21, 2004, which is incorporated herein by reference.

What is claimed is:

1. A separator for non-aqueous electrolyte batteries, comprising:
a microporous film in which a polyolefin layer and a heat-proof layer are adhered,
said heat-proof layer having a thickness of from 1 μm to 4 μm and being formed of a polyamide, polyimide, or polyamideimide having a melting point of 180° C. or higher, and
said separator having an air permeability of 200 sec/100 mL or less, measured according to JIS P8117.

2. The separator for non-aqueous electrolyte batteries according to claim 1, wherein said separator has a thickness of 10 μm or less.

3. The separator for non-aqueous electrolyte batteries according to claim 1, wherein the ratio of the thickness of said heat-proof layer to the thickness of said polyolefin layer (heat-proof layer:polyolefin layer) is (1):(1 or greater).

4. The separator for non-aqueous electrolyte batteries according to claim 2, wherein the ratio of the thickness of said heat-proof layer to the thickness of said polyolefin layer (heat-proof layer: polyolefin layer) is (1):(1 or greater).

5. The separator for non-aqueous electrolyte batteries according to claim 1, wherein said heat-proof layer is formed of para-aromatic polyamide.

6. The separator for non-aqueous electrolyte batteries according to claim 1, wherein said polyolefin layer is formed of polyethylene.

7. A non-aqueous electrolyte battery comprising: a positive electrode containing a positive electrode active material, a negative electrode containing a negative electrode active material, and a separator interposed between said positive electrode and said negative electrode, wherein
said separator is a separator according to claim 1.

8. The non-aqueous electrolyte battery according to claim 7, wherein said positive electrode active material is lithium-cobalt composite oxide or lithium-nickel composite oxide, and said negative electrode active material is a carbon material.
